(19) United States
(12) Patent Application Publication
(10) Pub. No.: US 2010/0229699 A1
(43) Pub. Date: Sep. 16, 2010

(54) Fully-opened-storable driver handle assembly

(76) Inventor: Yung-Hsu Huang, Taichung County (TW)

Correspondence Address: Yung-Hsu Huang, P.O. Box 44-2049, Taipei, 10668, TW

(21) Appl. No.: 12/382,206

(22) Filed: Mar. 11, 2009

(51) Int. Cl. B25G 1/08

(52) U.S. Cl. 81/490

(57) ABSTRACT

The invention provides a fully-opened-storable driver handle assembly having the following main structure. A handle is formed with a chamber dug inwardly from a lateral side thereof, and is connected to a storage seat at its rear end through a shaft rod, wherein the storage seat may be rotated into and out of the chamber with the shaft rod serving as a fulcrum. An elastic sheet disposed at a front end of the storage seat engages with a notch formed at a front end of the chamber so that the combination state between the storage seat and the handle may be fixed. Thus, the storage seat may be opened laterally so that the user can rapidly take and replace the tool head mounted on the storage seat, the working efficiency can be enhanced, and the convenience of replacing the tool can-be enhanced.

### BACKGROUND OF THE INVENTION

(1) Field of the Invention

The invention relates to a fully-opened-storable driver handle assembly, and more particularly to a structure, in which a storage seat capable of accommodating-tool heads may be accommodated within and connected to a handle of a driver, and the storage seat may be opened laterally.

(2) Description of the Prior Art

In the daily life, sleeve tools of drivers are widely used. Thus, a driver tool set, which has multiple specifications or types of sleeve tools and may be attached to a single driver tool, has been developed. As shown in FIG. 1, the structure is configured such that a middle section of a driver 10 is formed with a receiving slot 12. A storage seat 13 may be placed within the receiving slot 12, and a base 15 is connected to a bottom end of the receiving slot 12. Multiple driver heads 14 with different specifications or sizes may be placed on the storage seat 13.

When the user wants to replace or mount the driver head 14, he or she has to remove the base 15 first, then take the driver head 14 in the storage seat 13, and then combine the driver head 14 with a driver rod 1 1. Thus, multiple tools may be replaced conveniently, and the cost of purchasing the tools may be effectively lowered.

However, the structure design of the changeable driver device has the following drawbacks.

First, the driver head on the storage seat cannot be taken and replaced until the base is removed. Thus, the replacement is complicated, the operation speed is lowered, and the efficiency is decreased.

Second, the storage seat is not connected to the driver structure. Thus, when the user is operating, the removed storage seat tends to be lost so that the operation is troublesome and the problem has to be solved.

### SUMMARY OF THE INVENTION

In view of the drawbacks of the conventional changeable driver device in use, the present inventor has paid attention to the research and development according to the experience and the technology in manufacturing the associated products, and thus developed a driver handle assembly, which is mainly directed to the fully-opened-storable driver handle assembly of FIG. 3, wherein a storage seat is connected to a handle using a shaft rod and may be laterally opened with the shaft rod serving as a fulcrum so that the storage seat may be rotated into and out of the chamber of the handle.

Another object of the invention is to let the user rapidly take and replace the tool head to be used according to the lateral opening design of the storage seat. In addition, the storage may be immediately retracted into the chamber of the handle after the storage seat is not used. Thus, it is possible to prevent the tools from being lost and to enhance the smoothness of the operation.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a conventional changeable driver structure.

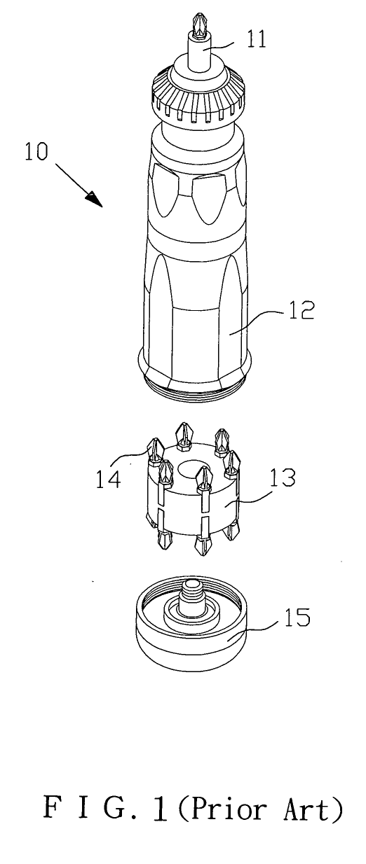

FIG. 2 is a pictorial view showing the invention.

FIG. 3 is a decomposed schematic illustration showing the invention.

FIG. 4 is a schematic illustration showing the elastic sheet engaging with the notch according to the invention.

FIG. 5 is a first pictorial view showing the embodiment of the invention.

FIG. 6 is a second pictorial view showing the embodiment of the invention.

### DETAILED DESCRIPTION OF THE PREFERRED EMBODIMENTS

The technological means and effectiveness of the invention will further be described in detail with reference to the accompanying drawings.

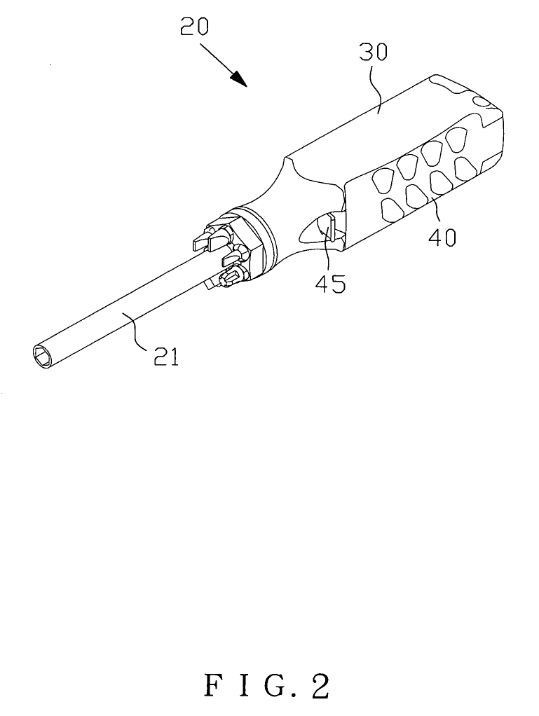

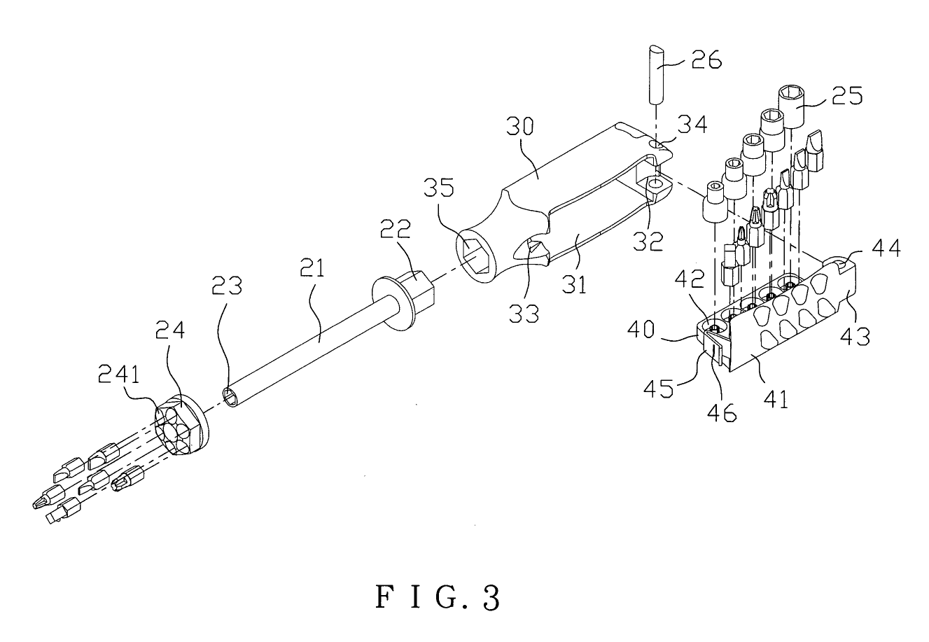

Referring first to FIGS. 2 and 3, a driver 20 of the invention is mainly composed of a handle 30, a driver rod 21 and a storage seat 40, all of which are combined together. The handle 30 is formed with a chamber 31, which is dug inwardly from a lateral side thereof. A slot 32 is formed at a rear end of the chamber 31 in advance. In addition, a shaft hole 34 penetrating through top and bottom ends of the handle 30 is formed in the slot 32. Also, a notch 33 is formed at the front end of the handle 30 and the front end of the chamber 31. The storage seat 40 is formed with several accommodating holes 42 for accommodating several tool heads 25 with various specifications or types. An external side of the storage seat 40 is connected to a cover 41. A rear end of the cover 41 is connected to a lug 43, which is formed with a lug hole 44. Also, an elastic sheet 45 is disposed at a front end of the cover 41. The storage seat 40 may be placed into the chamber 31 of the handle 30, and the lug 43 of the storage seat 40 is combined with the slot 32 of the handle 30. A shaft rod 26 is inserted into the shaft hole 34 and the lug hole 44 to fix and position the storage seat 40 to the rear end of the handle 30. After the storage seat 40 is combined with the handle 30, the outer peripheries of the cover 41 and the handle 30 are integrated together.

Next, the driver rod 21 is inserted into a through hole 35 corresponding to the front end of the handle 30 via a connector 22 at the rear end thereof, and the front end of the driver rod 21 is inwardly formed with a rod hole 23. In addition, the driver rod 21 may be combined with a slotted seat 24, which is formed with a plurality of seat holes 241 for accommodating the plurality of tool heads 25.

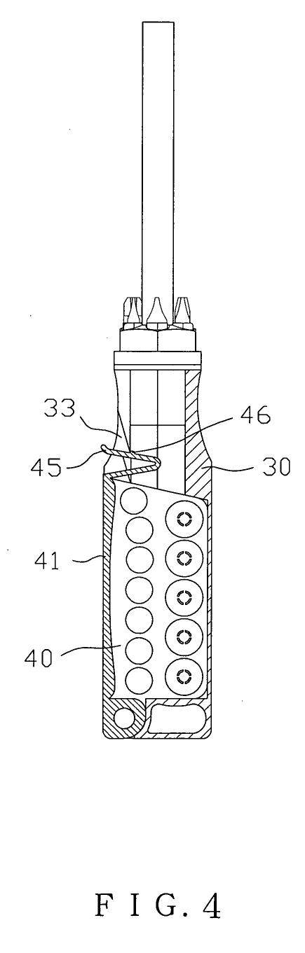

Furthermore, as shown in FIG. 4, when the storage seat 40 is placed into the chamber 31 of the handle 30, the elastic sheet 45 is pressed by the notch 33 of the handle 30 to enter the compressed state. An engaging projection 46 disposed on the elastic sheet 45 engages with the inner end of the notch 33 to restrict the positions of the storage seat 40 and the handle 30 when the storage seat 40 and the handle 30 are combined.

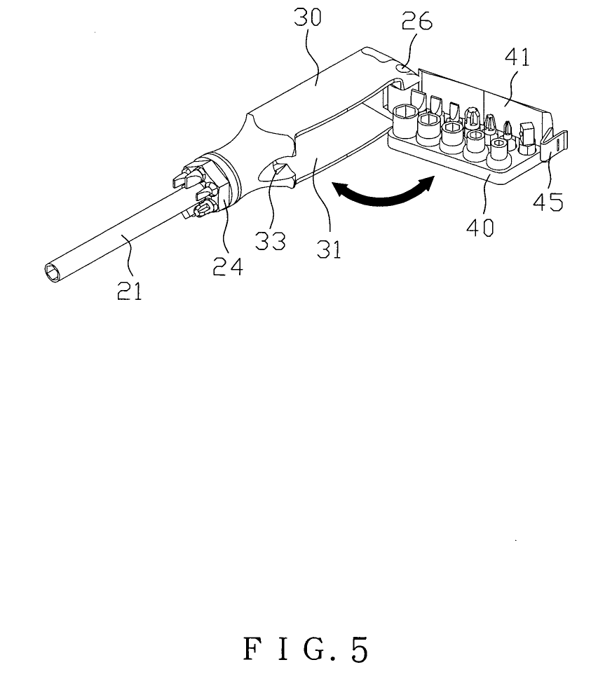

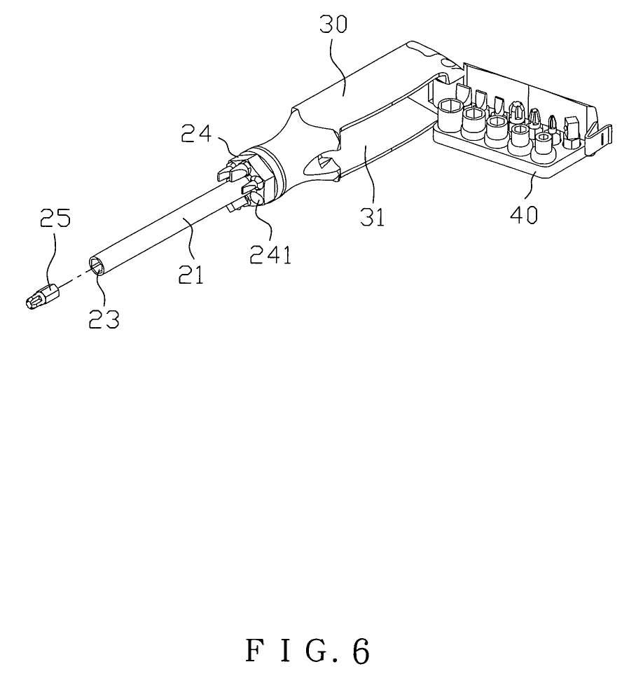

In addition, as shown in FIGS. 5 and 6, the storage seat 40 may be opened laterally, and rotated into and out of the chamber 31 with the shaft rod 26 serving as a fulcrum, and the tool head 25 to be used may be attached to the rod hole 23 at the front end of the driver rod 21. Thus, the tool head may be easily taken, mounted and replaced and the working state can be rapidly restored.

Also, the handle 30 may be made of a transparent material, and the overall structure of the storage seat 40 may be made of an opaque coloring material so that the user can recognize the sizes and types of the tool heads 25 placed therein through the transparent material of the handle 30. In addition, the color difference of the storage seat 40 enables the user to easily recognize its opening position in operation.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A fully-opened-storable driver handle assembly, mainly comprising:
a handle formed with a chamber and a slot, which are dug inwardly from a lateral side of the handle, wherein a shaft hole penetrating through top and bottom ends of the handle is formed in the slot, and a notch is formed at a front end of the handle in advance;
a storage seat having a top end formed with a plurality of accommodating holes, and an external side connected to a cover, wherein a rear end of the cover is connected to a lug, which is formed with a lug hole, and an elastic sheet formed with an engaging projection is disposed at a front end of the cover;
a shaft rod inserted into the shaft hole of the handle and the lug hole of the storage seat;
a driver rod having a front end inwardly formed with a rod hole; and
a slotted seat formed with a plurality of seat holes, wherein the driver rod penetrates through the slotted seat, wherein:
the lug of the storage seat is combined with the slot of the handle and the shaft rod is inserted into the shaft hole and the lug hole so that the storage seat can be laterally opened and rotated into and out of the chamber of the handle with the shaft rod serving as a fulcrum.

2. The driver handle assembly according to claim 1, wherein tool heads are placed in the accommodating holes of the storage seat and the seat holes of the slotted seat.

3. The driver handle assembly according to claim 1, wherein when the storage seat is combined with the handle, the engaging projection of the elastic sheet engages with an inner end of the notch of the handle.

4. The driver handle assembly according to claim 1, wherein the driver rod is inserted into a through hole corresponding to the front end of the handle via a connector disposed at a rear end of the driver rod.

5. The driver handle assembly according to claim 1, wherein the handle is made of a transparent material or an opaque material.

6. The driver handle assembly according to claim 1, wherein the storage seat is made of an opaque material.
